(19) United States
(12) Patent Application Publication
(10) Pub. No.: US 2007/0123157 A1
(43) Pub. Date: May 31, 2007

(54) Structurally-integrated HVAC duct

(76) Inventors: Sanjay M. Shah, Troy, MI (US); Charles J. Bruggemann, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/290,698

(22) Filed: Nov. 30, 2005

(51) Int. Cl. B60S 1/54

(52) U.S. Cl. 454/121

(57) ABSTRACT

The invention concerns an automotive vehicle having a roof pillar defining a structurally-integrated HVAC duct. The structurally-integrated HVAC duct includes an interior surface having an insulating coating covering the surface. The invention also concerns a method of forming a structural HVAC duct that includes coating a surface that forms an interior of the duct with an insulating coating.

### BACKGROUND OF INVENTION

The present invention relates generally to an HVAC duct in a vehicle, and in particular to an HVAC duct integrated into a roof pillar of an automotive vehicle and a method of forming the duct.

In many automotive vehicles today, the heating, ventilation and air conditioning (HVAC) system includes vents in or near the headliner. Sport utility, multi-activity, and station wagons, in particular, may include such vents, which may receive air from a rear auxiliary unit. A blower, and other components of the auxiliary system, are typically located in a side wall with ducts extending up along or within one or more of the roof pillars to direct air to these upper vents. For auxiliary HVAC units, the ducts typically extend along or within one or more of the C-pillars and D-pillars. Separate ducts are employed because an insulating layer is needed between the heated or cooled air flowing through the ducts and the metal (typically steel or aluminum) roof pillars, which are not effective for maintaining the temperature of the flowing air.

If the HVAC duct will be contained between two or more stampings, then a separate insulating HVAC duct is typically inserted between the stampings before the stampings are permanently secured together. If the HVAC duct will be contained within a closed section that does not have any severe bends, then the separate HVAC duct is also typically mounted inside the closed section. Unfortunately, the separate duct has fabrication and assembly costs, which add to the cost of the vehicle. Moreover, in both of these cases, the materials for this duct are relatively expensive since they must maintain their shape while withstanding the high temperatures of a paint oven. If the roof pillar includes a closed section that does have severe bends, then a separate HVAC duct is typically mounted adjacent to but outside of the closed section. Not only are the extra fabrication and assembly costs incurred with this adjacent duct, but the duct now takes up extra space.

Thus, it is desirable to eliminate the extra cost of fabrication and assembly—and sometimes extra space taken—for these HVAC ducts running through or along roof pillar components.

### SUMMARY OF INVENTION

An embodiment of the present invention contemplates an automotive vehicle having a body with a roof and a roof pillar extending to and supporting the roof. The roof pillar includes at least one hollow structural member defining a structural HVAC duct including an interior surface for airflow there through, and having an insulating coating covering substantially the entire interior surface.

An embodiment according to the present invention may also contemplate a method of forming a structural HVAC duct that is defined by a portion of a roof pillar in an automotive vehicle, the method comprising the steps of: (a) providing at least one metal blank; (b) coating a surface of the at least one metal blank with an insulating coating; (c) forming the at least one metal blank into a hollow structural member defining the structural HVAC duct after step (b); and (d) assembling the roof pillar to the automotive vehicle.

An advantage of an embodiment of the present invention is that the structurally integrated HVAC duct provides a path for directing air flow without requiring the expense of fabricating and assembling an extra duct to provide this flow path.

Another advantage of an embodiment of the present invention is that the structurally integrated HVAC duct saves space in vehicles having a pillar with a severe bend since a separate duct does have to be mounted outside of the vehicle pillar.

An additional advantage of an embodiment of the present invention is that the structurally integrated HVAC duct provides an insulating effect to assure that the temperature of the air flowing through the duct is substantially maintained.

### BRIEF DESCRIPTION OF DRAWINGS

FIG. 1 is a rear perspective view of a portion of an automotive vehicle, in accordance with the present invention.

FIG. 2 is a perspective view of the D-ring portion of the automotive vehicle of FIG. 1.

FIG. 3 is an exploded perspective view of a portion of the D-ring of FIG. 2.

FIG. 4 is a schematic cross section view of coated sheet metal that is employed to form the structural HVAC duct illustrated in FIG. 3.

FIG. 5 is a schematic cross section through the structural HVAC duct of FIG. 3.

FIG. 6 is an exploded perspective view similar to FIG. 3, but illustrating a second embodiment of the present invention.

FIG. 7 is a schematic cross section view of a coated tube that is employed to form the structural HVAC duct illustrated in FIG. 6.

FIG. 8 is a schematic cross section through the structural HVAC duct of FIG. 6.

### DETAILED DESCRIPTION

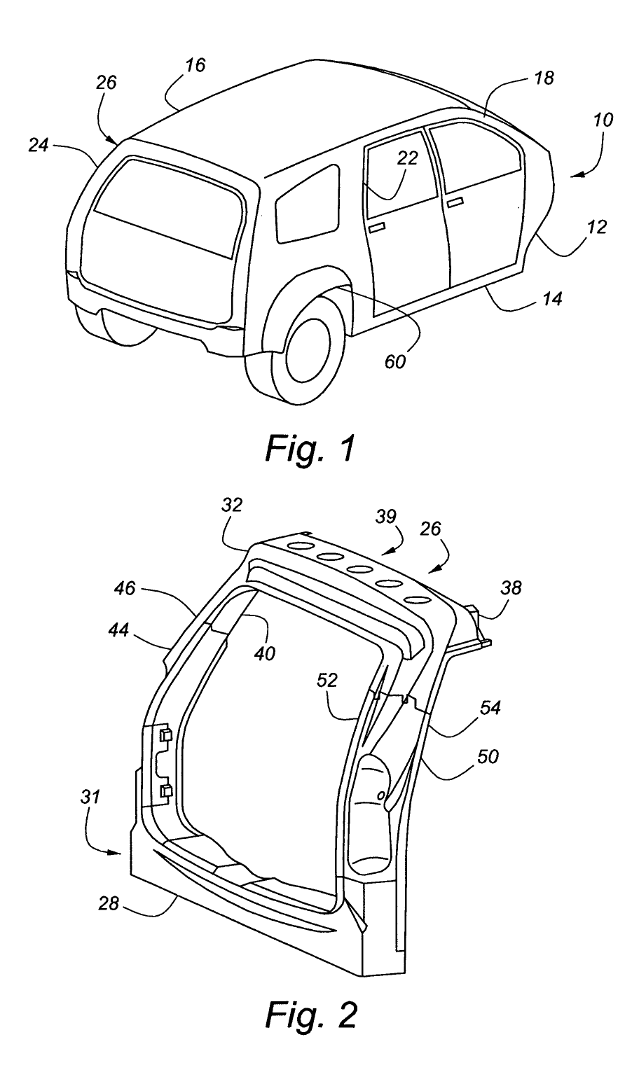

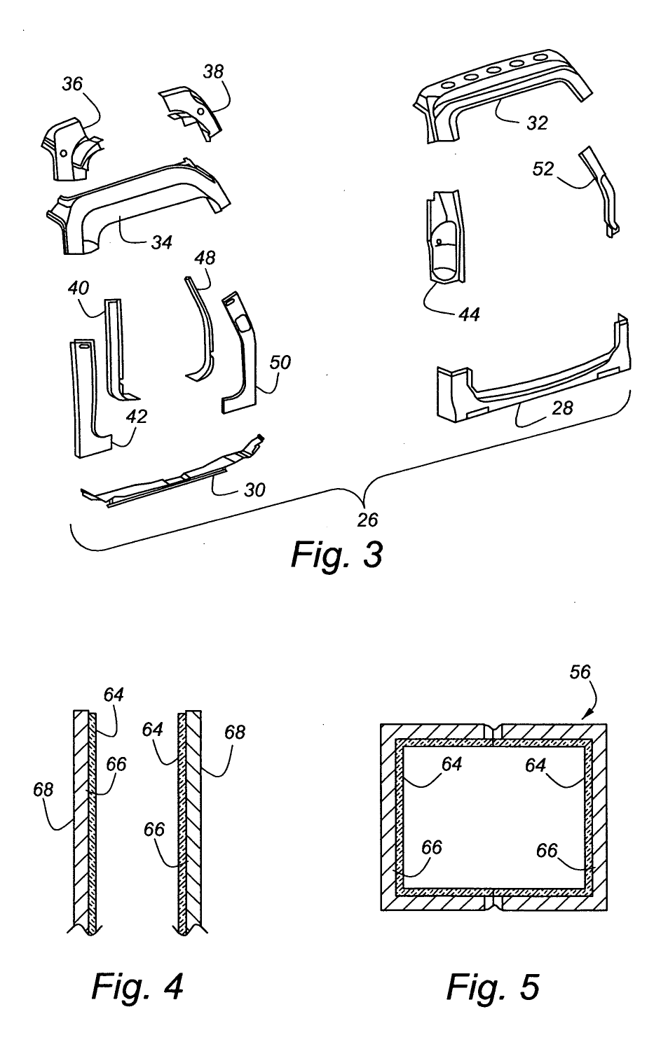

FIGS. 1-3 illustrate a vehicle, indicated generally at 10, and portions thereof, in accordance with a first embodiment of the present invention. The vehicle 10 has a vehicle body 12 with a floor 14 and a roof 16 that define a vehicle interior. The frame also includes A-pillars 18, B-pillars (not shown), C-pillars 22, and D-pillars 24 that support the roof 16. The D-pillars 24 are part of a D-ring 26, which defines the rear and rear opening of the body 12.

The D-ring 26 includes a lower outer D-ring member 28 and a lower inner D-ring member 30 that define a lower portion 31 of the D-ring 26. An upper outer D-ring member 32, an upper inner D-ring member 34, a left upper reinforcement member 36, and a right upper body reinforcement member 38 define an upper portion 39 of the D-ring 26. A left inner pillar D-ring member 40, a left inner pillar D-ring panel 42, and a left outer pillar D-ring member 44 define a left side of the D-ring 26, as well as forming the left pillar 46 of the D-pillars 24. A right inner pillar D-ring member 48, a right inner pillar D-ring panel 50, and a right outer pillar D-ring member 52 define a right side of the D-ring 26, as well as forming the right pillar 54 of the D-pillars 24.

The right pillar 54 and a portion of the upper portion 39 of the D-ring 26 also defines a structural HVAC duct 56 (Shown in FIG. 5). The term structural, as used herein, means that the particular component or components are load bearing or otherwise provide some type of support for the vehicle body. This HVAC duct 56 is a hollow closed section extending through the right D-pillar 54 and part of the way through the upper portion 39. The hollow space is employed to direct warm/cool air there through. A lower open end of the HVAC duct 56 may be in fluid communication with a portion of an auxiliary HVAC unit (not shown) mounted in a side wall (not shown) near a rear wheel well 60 of the vehicle 10. An upper open end of the HVAC duct 56 is typically in fluid communication with a duct/vent (not shown) that extends under the roof 16 and directs air flow into the vehicle interior. The vehicle structural members that combine to form the structural HVAC duct 56 include an insulating coating 64 covering their interior surfaces 66, as is shown and will be described in more detail with reference to FIGS. 4 and 5. For this embodiment, all or portions of the interior surfaces of the right inner pillar D-ring member 48, the right inner pillar D-ring panel 50 and the right outer pillar D-ring member 52, as well as the upper outer D-ring member 32 and the upper inner D-ring member 34, would be coated with the insulating coating 64.

FIG. 4 is a schematic illustration of a pair of blanks 68. The blanks 68 may be formed from, for example, a metal such as steel. The blanks 68 illustrate the sheet metal that may be used to form the structural members that combine to define the structural HVAC duct. Each of the blanks 68 is coated on one surface with the insulating coating 64, which is preferably applied prior to stamping and assembly operations. It is preferably applied prior to these operations because the structural HVAC duct 56 is a closed section and may include severe bends, which would make application of an insulating coating much more difficult after the HVAC duct 56 is formed. The insulating coating 64 can be, for example, a polyester urethane solvent based coating. This material is particularly suited for use as the insulating coating 64 since it provides a good insulating effect while also having the flexibility needed during the part forming process and the temperature resistance needed when the vehicle frame is being subjected to a high temperature oven bake. Alternatively, if reduced cost is a more significant factor than flexibility of the material during forming, the insulating coating 64 may be formed from a polyester melamine coating. Other examples of alternative materials for the insulating coating 64 may be a flexible phenolic, an epoxy-based coating, an acrylic-based coating, or a suitable cross-linked, thermoset material with the desired insulating properties.

FIG. 5 shows a schematic cross section of the structural HVAC duct 56 that results from the forming and assembly operations performed on the blanks 68 of FIG. 4. Each of the blanks 68 is formed into one of the D-ring members through, for example, a stamping operation. The formed portions are then assembled and secured together into a closed section that has the insulating coating 64 covering essentially the entire interior surface 66. The formed portions may be secured together as part of the D-ring and vehicle body by, for example, spot welding, laser welding, adhesives, rivets, or other suitable attachment methods. Thus, a structural HVAC duct 56 is formed having the insulating coating 64 to minimize the thermal transfer through the wall of the structural HVAC duct 56. In the alternative, the insulating coating 64 may be applied inside the structural HVAC duct 56 after the forming or assembly operations.

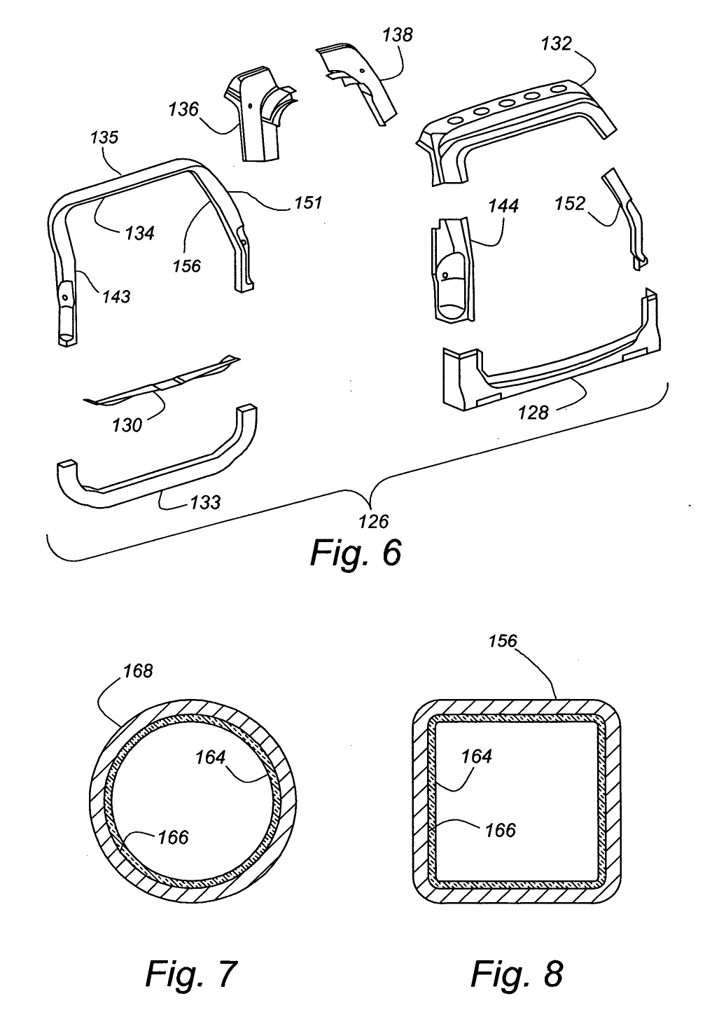

FIG. 6 illustrates a D-ring 126, according to a second embodiment of the present invention, that may be employed with the vehicle of FIG. 1. The elements in this embodiment are similar to the first, except that some are preferably formed by a hydroforming process rather than a stamping process. Thus, in this embodiment, elements that are similar to those in the first embodiment will be similarly designated, but with 100-series numbers.

The D-ring 126 includes a lower outer D-ring member 128, a lower D-ring hydroformed member 133, and a lower inner D-ring member 130 that define a lower portion of the D-ring 126. An upper outer D-ring member 132, a first portion 135 of an upper D-ring hydroform member 134, a left upper reinforcement member 136, and a right upper body reinforcement member 138 define an upper portion of the D-ring 126. A second portion 143 of the upper D-ring hydroform member 134 and a left outer pillar D-ring member 144 define a left side of the D-ring 126, as well as forming the left pillar of the D-pillars. A third portion 151 of the upper D-ring hydroform member 134, and a right outer pillar D-ring member 152 define a right side of the D-ring 126, as well as forming the right pillar of the D-pillars.

In this embodiment, the structural HVAC duct 156 is defined by the third portion 151 and part of the first portion 135 of the upper D-ring hydroform member 134. This structural HVAC duct 156 is again a hollow closed section where the hollow space is employed to direct warm/cool air. As with the first embodiment, a lower open end may be in fluid communication with a portion of an auxiliary HVAC unit (not shown) that may be mounted in, for example, a side wall (not shown) near a rear wheel well of the vehicle (shown in FIG. 1). An upper open end may be in fluid communication with a duct/vent (not shown) that extends under the roof and directs air flow into the vehicle interior. The structure that defines the structural HVAC duct 156 includes an insulating coating 164 covering the interior surface 166, as is shown and will be described in more detail with reference to FIGS. 7 and 8. As with the first embodiment, the insulating coating 164 minimizes the thermal transfer through the wall of the duct 156.

FIG. 7 is a schematic illustration of a tubular blank 168, which may be formed from, for example, a metal such as steel. Preferably, a sheet material—prior to making the tubular blank 168—is coated on one side with the insulating coating 164. The insulating coating 164 may be similar to those examples suggested with reference to the first embodiment. The sheet material is then formed into the tubular blank 168 and secured by, for example, welding. Thus, the tubular blank 168 will include the insulating material 164 on its interior surface 166.

FIG. 8 shows a schematic cross section of the structural HVAC duct 156 that results from a hydroforming operation performed on the blank 168 of FIG. 7. Preferably, for a hydroforming operation when the duct 156 includes sever bending, care is taken in selecting the mandrel material and clearance between the mandrel (not shown) and the inside dimensions of tubular blank 168. This will assure that the hydroforming operation will not adversely affect the insulating coating 164. In the alternative, the insulating coating 164 may be applied inside the structural HVAC duct 156 after the hydroforming operation. The formed closed section has the insulating coating 164 covering essentially the entire interior surface 166, thus providing a thermal barrier for air flowing through it.

Even though the example embodiments discussed herein are directed to a structural HVAC duct defined by structure of the D-pillar, other hollow closed section body members may form the HVAC duct having the insulating material coating therein. For example, the structural HVAC duct with insulating material can form a part of one of the other roof pillars, such as a C-pillar of the vehicle. Thus, while certain embodiments of the present invention have been described in detail, those familiar with the art to which this invention relates will recognize various alternative designs and embodiments for practicing the invention as defined by the following claims.

What is claimed is:

1. An automotive vehicle having a body with a roof comprising:
a roof pillar extending to and supporting the roof, the roof pillar including at least one hollow structural member defining a structural HVAC duct including an interior surface for airflow therethrough, and having an insulating coating covering substantially the entire interior surface.

2. The automotive vehicle of claim 1 wherein the insulating coating is a polyester melamine coating.

3. The automotive vehicle of claim 1 wherein the insulating coating is a polyester urethane solvent based coating.

4. The automotive vehicle of claim 3 wherein the at least one hollow structural member is made of steel.

5. The automotive vehicle of claim 4 wherein the roof pillar is a D-pillar.

6. The automotive vehicle of claim 1 wherein the at least one hollow structural member is formed from at least two stamped members.

7. The automotive vehicle of claim 1 wherein the roof pillar is a D-pillar.

8. The automotive vehicle of claim 1 wherein the at least one hollow structural member is made of a hydroformed metal.

9. The automotive vehicle of claim 1 wherein the at least one hollow structural member is made of stamped metal.

10. The automotive vehicle of claim 1 wherein the insulating coating is made from one of a flexible phenolic coating, an epoxy-based coating, and an acrylic-based coating.

11. A method of forming a structural HVAC duct that is defined by a portion of a roof pillar in an automotive vehicle, the method comprising the steps of:
(a) providing at least one metal blank;
(b) coating a surface of the at least one metal blank with an insulating coating;
(c) forming the at least one metal blank into a hollow structural member defining the structural HVAC duct after step (b); and
(d) assembling the roof pillar to the automotive vehicle.

12. The method of claim 11 wherein step (c) is further defined by employing a hydroforming process to form the hollow structural member.

13. The method of claim 12 wherein step (b) is further defined by the insulating coating being a polyester urethane solvent-based coating.

14. The method of claim 13 wherein step (a) is further defined by the at least one metal blank being made of steel.

15. The method of claim 11 wherein step (b) is further defined by the insulating coating being a polyester urethane solvent-based coating.

16. The method of claim 11 wherein step (c) is further defined by employing a stamping process to form the hollow structural member.

17. The method of claim 11 wherein step (b) is further defined by the insulating coating being a polyester melamine coating.

18. The method of claim 11 wherein the roof pillar is a D-pillar.

19. The method of claim 11 further including the step of: (e) exposing the and roof pillar to a high temperature bake, after step (d).

20. A method of forming a structural HVAC duct that is defined by a portion of a D-pillar in an automotive vehicle, the method comprising the steps of:
(a) providing at least one metal blank;
(b) coating a surface of the at least one metal blank with an insulating coating including a cross-linked thermoset material;
(c) forming the at least one metal blank into a hollow structural member defining the structural HVAC duct; and
(d) assembling the D-pillar to the automotive vehicle.
